(19) United States
(12) Patent Application Publication
(10) Pub. No.: US 2014/0365613 A1
(43) Pub. Date: Dec. 11, 2014

(54) DEFRAGMENTATION OF ADAPTIVE STREAMING SEGMENT FILES IN A CONTENT DELIVERY NETWORK

(71) Applicant: Ericsson Television Inc., Duluth, GA (US)

(72) Inventors: Christopher Phillips, Hartwell, GA (US); Charles Dasher, Lawrenceville, GA (US)

(21) Appl. No.: 13/923,005

(22) Filed: Jun. 20, 2013

Related U.S. Application Data
(60) Provisional application No. 61/831,906, filed on Jun. 6, 2013.

(51) Int. Cl. H04L 29/06

(52) U.S. Cl. CPC H04L 65/60
USPC 709/219

(57) ABSTRACT

An edge node, a parent node, and a method in a Content Delivery Network (CDN) configured to utilize adaptive streaming to deliver a piece of electronic content to requesting clients. The content includes a plurality of segment files referenced by an associated manifest document, and the nodes are configured to defragment an incomplete piece of content and ensure that a copy stored in each node contain all segment files referenced by the manifest document. Each node analyzes the manifest document and the segment files stored in its cache memory to determine whether any segment files referenced by the manifest document are absent from the memory. If so, the node pulls the absent segment files from another node in the CDN to complete the piece of content. The defragmentation may be performed during a period of minimum network usage to minimize network impact and within a popularity time window to ensure timely storage of the defragmented content in each node.

### CROSS-REFERENCE TO RELATED APPLICATIONS

This application claims the priority benefit under 35 U.S.C. §119(e) of U.S. Provisional Application No. 61/831,908 filed on Jun. 6, 2013, the disclosure of which is incorporated herein by reference in its entirety.

### TECHNICAL FIELD

The present disclosure relates to communication systems. More particularly, and not by way of limitation, particular embodiments of the present disclosure are directed to a nodes and methods in a Content Distribution Network (CDN) for distributing electronic content to servers throughout the CDN.

### BACKGROUND

Content Distribution Networks (CDNs) generally operate by distributing complete files across the nodes (servers) that comprise the distribution network. A central server known as a redirector handles requests for files and responds by returning a different Uniform Resource Identifier (URI) for a given file (redirection). In other cases, a Domain Name System (DNS) server may respond with a different IP Address for a given host name for the URI of the file. Centralized management software may determine the best way to distribute the files out to the edge of the CDN based on external data such as popularity, network congestion, or other factors.

Adaptive streaming, sometimes called adaptive bitrate streaming, is a technique based, in most applications, on the Hypertext Transfer Protocol (HTTP) used for streaming multimedia over large distributed HTTP networks. The media source detects a users bandwidth and CPU capacity in real time and adjusts the quality of a video stream accordingly using a multi-rate encoder capable of encoding a single source video at multiple bitrates. This generally results in very little buffering, fast start times, and a good experience for both high-end and low-end connections.

More specifically, the source content is encoded at multiple bitrates, and each of the different bitrate streams is segmented into small segment files containing several seconds' worth of content. The segment-file size can vary depending on the particular implementation, but the segment files are typically in the range of two to ten seconds in length. A manifest file provides the streaming client with information about the available streams, their differing bitrates, and segments of the streams. When starting, the client requests the segment files from the lowest bitrate stream. If the client finds the download speed is greater than the bitrate of the downloaded segment file, then the client will request the segment files from the next higher bitrate. Later, if the client finds the download speed for a segment file is lower than the bitrate for the segment file, and therefore the network throughput has deteriorated, the client requests a lower bitrate segment file.

### SUMMARY

Due to the architecture and mechanism for adaptive streaming, when clients access adaptive streaming content via a CDN, there is a high probability that servers at the edge will become fragmented, i.e., they will hold incomplete copies of the content. Nodes at the edge of the CDN (edge servers) may serve one or many individual segment files to a client. When the client requests content from a second edge server, both the first edge server and the second edge server may hold an incomplete collection of the segment files referenced by the associated manifest. This results in fragmentation of the media, resulting in inefficiencies and additional network load when the client attempts to pull an entire collection of segment files from a single edge server.

When edge servers do not hold a copy of a requested segment file, they must pull the requested segment file from a parent node such as a regional server. While this generally causes the parent node to hold a complete copy of the requested segment files, there is no guarantee that a complete manifest segment collection will reside on the parent node for all advertised bitrates. Fragmentation occurs when clients request some, but not all, of the segment files for an adaptive streaming manifest from the same edge server resulting in an incomplete copy of the entire manifest segment collection. Clients changing bitrates within an adaptive streaming architecture can compound this fragmentation on an edge server even further.

As a solution, particular embodiments of the present disclosure provide a “defragmentation” system and method within a CDN where adaptive streaming content is utilized. The system and method ensures that edge servers hold a complete copy of the entire manifest segment collection. Further, this “defragmentation” method may be controlled to occur at times of low network utilization, and the method may take into account the anticipated need for the content so as to avoid unnecessarily pre-staging segment files when they are unlikely to be requested.

In one embodiment, the present disclosure is directed to a method in which an edge node in a CDN determines whether there are any segment files referenced by a manifest document that are absent from the edge node's local cache and if so, the edge node pulls the absent segment files from another node in the CDN such as its parent node or another edge node. Prior to pulling the absent segment files from the other node, the edge node may determine that the current time is within a period of minimum usage of network resources. The edge node may also determine that a manifest popularity time is within a window threshold so that segment files are staged in a timely manner for when clients are likely to request them. When all segment files are cached in the edge node, the edge node reports completion of its defragmentation to its parent node.

If a segment file requested by an edge node from its parent node is also absent from the parent node's local cache, the parent node pulls the absent segment file from a higher level node in the CDN, stores the absent segment file in the parent node's local cache, and passes the file to the requesting edge node. In this way, the parent node caches or stores segment files requested by child edge nodes and fill gaps in the parent node's collection of segment files. Once all of the parent node's child edge nodes have reported that they have completed their defragmentation, the parent node checks its own manifests against its cached segment files to determine whether there are still any absent segment files and if so, pulls the absent segment file(s) from the higher level node. When all segment files are cached in the parent node, the parent node reports completion of its defragmentation to the higher level node. This method propagates up through the CDN until all nodes are defragmented and have reported their defragmented state to higher levels.

Embodiments disclosed herein describe edge nodes, parent nodes and methods performed in the edge nodes and the parent nodes.

One embodiment is directed toward a method in an edge node of a CDN for ensuring that a memory of the edge node contains all segment files referenced by an associated manifest document. The method includes the steps of analyzing the associated manifest document and the segment files stored in the memory of the edge node to determine whether any of the segment files referenced by the associated manifest document are absent from the memory of the edge node; and upon determining there are segment files referenced by the associated manifest document that are absent from the memory of the edge node, pulling the absent segment files from another node in the CDN and storing the pulled segment files in the memory of the edge node.

Another embodiment is directed toward an edge node of a CDN configured to utilize adaptive streaming to deliver a piece of electronic content to requesting clients, wherein the piece of electronic content comprises a plurality of segment files referenced by an associated manifest document. The edge node is configured to ensure that a memory of the edge node contains all segment files referenced by the associated manifest document. The edge node includes a processor that executes computer program instructions causing the edge node to analyze the associated manifest document and the segment files stored in the memory of the edge node to determine whether any of the segment files referenced by the associated manifest document are absent from the memory of the edge node; and upon determining there are segment files referenced by the associated manifest document that are absent from the memory of the edge node, pull the absent segment files from another node in the CDN and store the pulled segment files in the memory of the edge node.

Another embodiment is directed toward a parent node of a CDN configured to provide a piece of electronic content to a plurality of child nodes for further distribution to requesting clients utilizing adaptive streaming. The piece of electronic content comprises a plurality of segment files referenced by an associated manifest document, and the parent node is configured to ensure that a memory of the parent node contains all of the segment files referenced by the associated manifest document. The parent node includes a processor that executes computer program instructions causing the parent node to populate each of the plurality of child nodes with segment files requested by each child node, wherein when a requested segment file is absent from the memory of the parent node, the parent node is configured to pull the requested segment file from a higher level node in the CDN, to send the requested segment file to the requesting child node, and to store the requested segment file in the memory of the parent node. The parent node also determines that all of the plurality of child nodes have reported that their manifest documents are complete, and in response, analyzes the associated manifest document and the segment files stored in the memory of the parent node to determine whether any segment files referenced by the associated manifest document are still absent from the memory of the parent node. Upon determining there are segment files referenced by the associated manifest document that are still absent from the memory of the parent node, the parent node pulls the absent segment files from the higher level node in the CDN and stores the pulled segment files in the parent node.

The present disclosure ensures that clients requesting adaptive streaming content do not “fragment” the various edge servers they are redirected to for acquiring the segment files of the content. The disclosed nodes and methods enable a CDN to operate in an efficient manner during peak usage times when dealing with adaptive streaming content. A CDN that utilizes the disclosed nodes and methods gains efficiencies in network bandwidth utilization resulting in a better client experience. The predictive loading aspect based on factors such as content popularity ensures and reinforces efficient resource usage.

### BRIEF DESCRIPTION OF THE DRAWINGS

In the following section, the present disclosure will be described with reference to exemplary embodiments illustrated in the figures, in which:

FIG. 1 is an illustrative example of fragmentation of a master manifest when segment files are stored in different edge nodes of a CDN;

FIG. 2 is an illustrative drawing of an exemplary embodiment of a method for determining existing and absent manifest segment files in a node's local cache memory;

FIG. 3 is a flow diagram showing an exemplary embodiment of a method of segment defragmentation in a CDN;

FIG. 4 is a flow chart illustrating the steps of an exemplary embodiment of a segment defragmentation method performed by a child node such as an edge server in the CDN;

FIG. 5 is a flow chart illustrating the steps of an exemplary embodiment of a segment defragmentation method performed by a parent node such as a regional server in the CDN; and

FIG. 6 is a simplified block diagram of an exemplary embodiment of CDN node configured according to the present disclosure.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure. The disclosed system may be implemented, for example, in hardware or a combination of hardware and software such as one or more processors executing computer program instructions stored on a memory device.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing voice information or non-voice data/control information) to/from the second entity regardless of the type (analog or digital) of those signals. It is further noted that various figures (including component diagrams) shown and discussed herein are for illustrative purpose only, and are not drawn to scale.

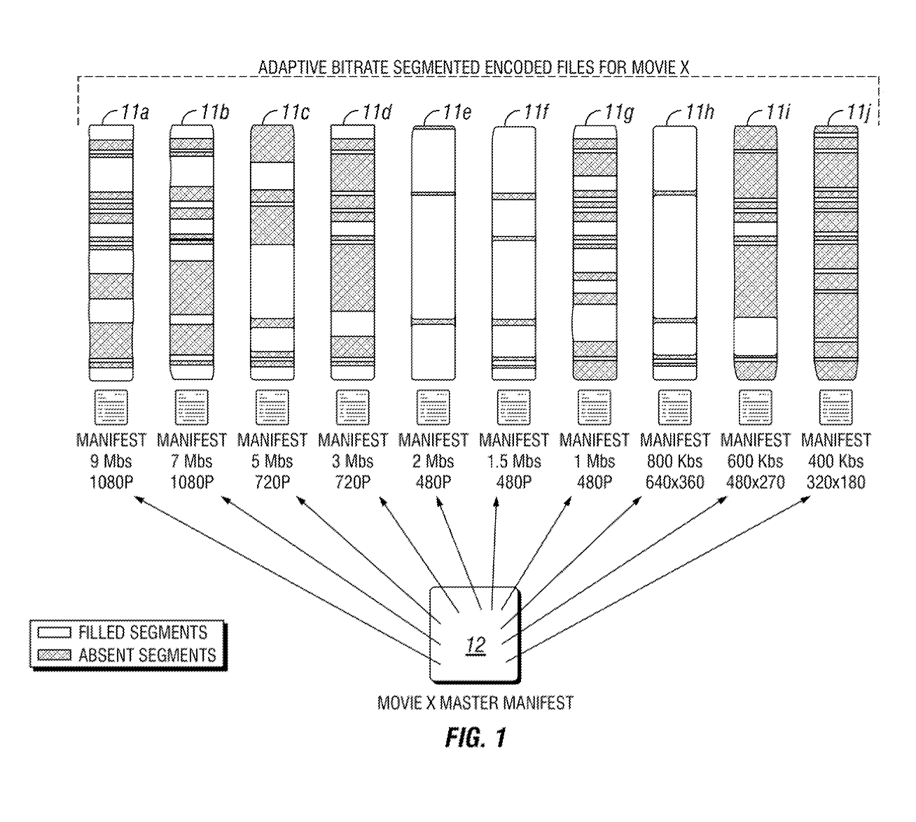

FIG. 1 is an illustrative example of fragmentation of a master manifest 12 when segment files 11a-11j are stored in different edge servers of a CDN. As a master manifest 12 of a Movie X is distributed through the CDN, segment files referenced by the master manifest may be distributed, for example, from an origin server to a plurality of regional servers, which serve as parent servers to child or edge servers. Other methods of distribution may also be utilized such as distributing from node to node on the same network level. As the edge servers pull manifest segment files for Movie X from parent to child nodes or from other edge servers, the collection of segment files residing on each edge server may become fragmented. In FIG. 1, the dark shaded areas illustrate segment files referenced by the manifest document that are absent from each edge server.

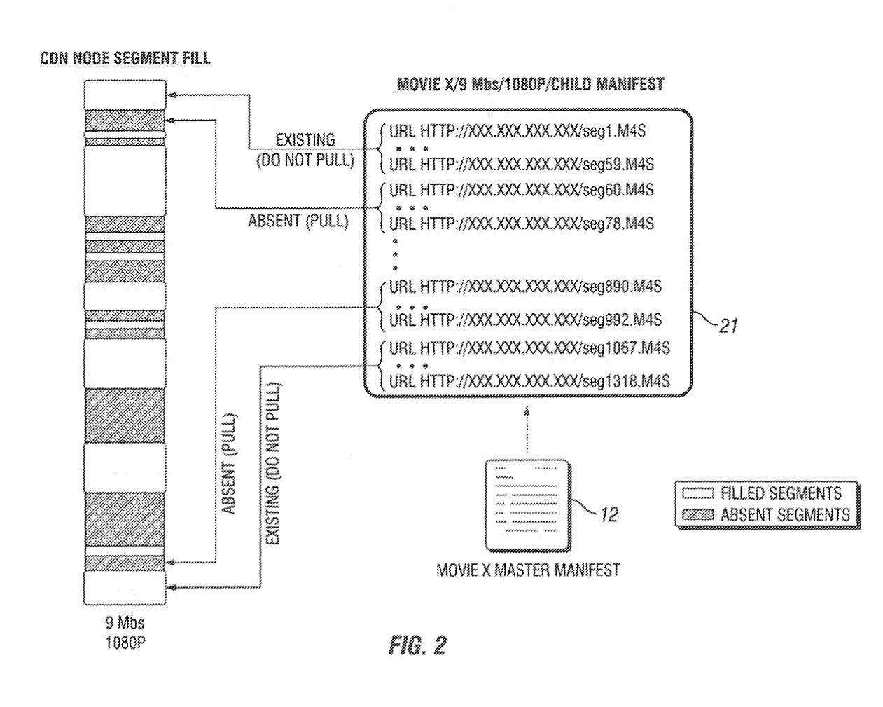

FIG. 2 is an illustrative drawing of an exemplary embodiment of a method for determining existing and absent manifest segment files in an edge node's local cache memory. The manifest document includes a list referencing the segment files that comprise the complete piece of electronic content. The edge node may analyze the manifest document and the stored segment files by reading the manifest document to identify which segment files are referenced by the manifest document, determining which segment files are present in the edge node's memory, and comparing the present segment files with the list to identify which segment files are absent. Each segment file has an assigned Uniform Resource Locator (URL), and if a segment file is determined to be absent from the edge node's memory, the edge node uses the URL of the absent segment file to request or pull the absent segment file from another node in the CDN. In one embodiment, the other node is the edge node's parent node, which may be a regional, national, or origin server of the CDN. In this manner, the edge node fills in the absent segment files referenced by a particular manifest or sub-manifest document.

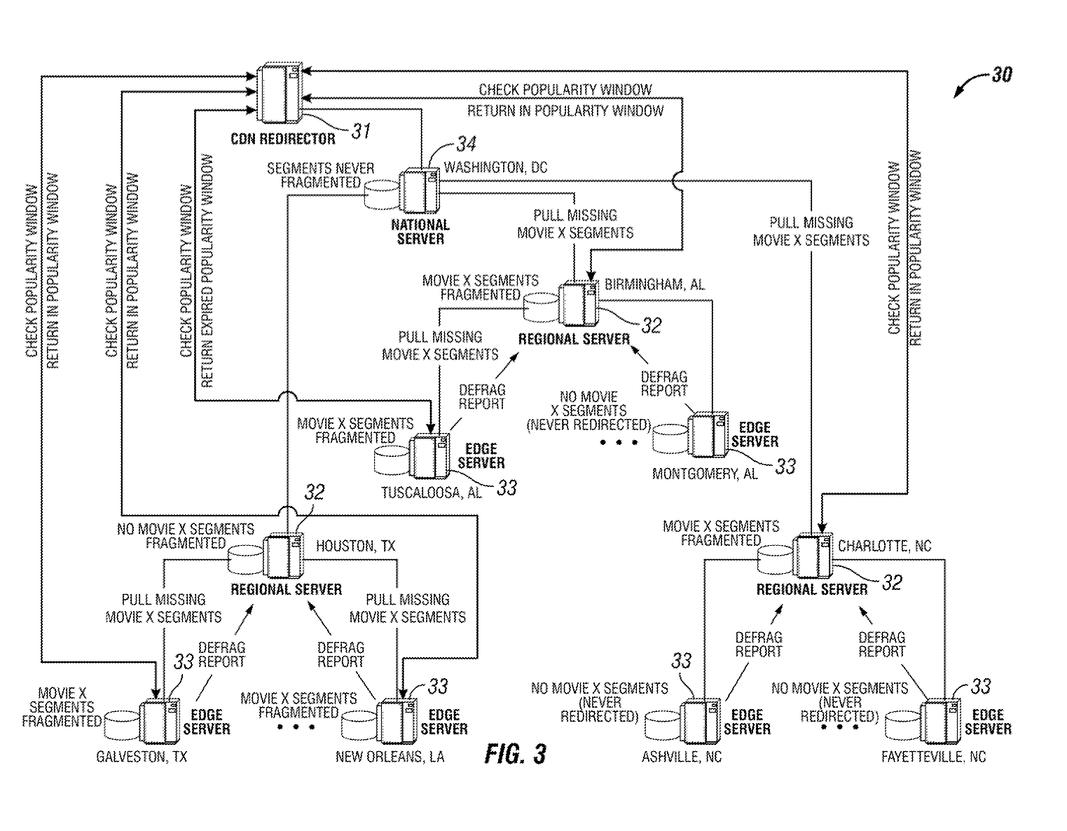

FIG. 3 is a flow diagram showing an exemplary embodiment of a method of segment defragmentation in a CDN 30. In this embodiment, a CDN Redirector server 31 is configured to “redirect” client requests for content to the URI of either a regional server 32 or an edge server 33 for segment acquisition. Additionally, the CDN Redirector server 31 communicates with an existing system (not shown) to request popularity metrics, scores, weights, or other measures along with, but not limited to, geographic location information to determine the popularity of a particular piece of content. The CDN Redirector server may also or alternatively use its own redirection history to determine which content qualifies as popular.

The CDN Redirector server 31 or another server may also inform child nodes of a “Minimum Usage Timeframe”, that is a time of day range in which network resources are determined to be near low usage levels. This Minimum Usage Timeframe may be determined by the CDN Redirector server or by another node within the CDN. In an embodiment of the disclosure, nodes first determine that the current time is within the minimum usage time frame before they begin the defragmentation process.

Child nodes are served by parent nodes, and during the defragmentation process, a request from a child node propagates through the parent node to fulfill the request for manifest segments. A parent node that is also missing the requested segment file may pull the absent segment file from a higher level node such as a national server 34, save the requested segment file, and forward the requested segment file to the requesting child node. Through this propagation, the parent node caches or stores segment files requested by one or more child nodes.

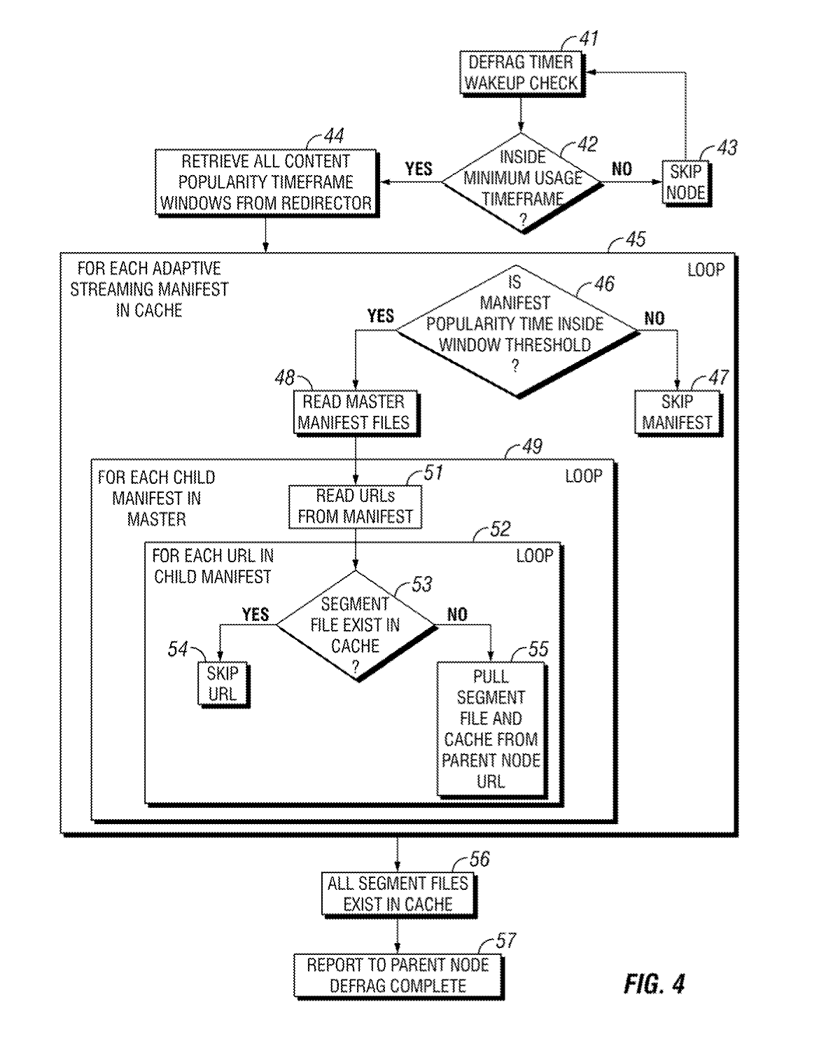

FIG. 4 is a flow chart illustrating the steps of an exemplary embodiment of a segment defragmentation method performed by a child node or edge node such as an edge server in the CDN. Boxes enclosing steps of the method indicate the enclosed steps are looped until, for example, all manifests have been analyzed or all absent segment files have been pulled from a parent node.

Each node within the CDN may determine at various time intervals whether the current time falls within the node's Minimum Usage Timeframe, Nodes that do not provide self-calculating timeframes may send a request to the node's parent node, the CDN Redirector server, or another server to determine its Minimum Usage Timeframe. Thus, at step 41, the edge node checks a defragmentation wakeup timer, which causes the edge node to determine at step 42 whether the current time is within the period of minimum usage of network resources within the CDN. The edge node may self-calculate the period of minimum usage of network resources if able, and if not able, the edge node receives information identifying the period of minimum usage of network resources within the CDN from its parent node, the Redirector server 31, or another server in the CDN. If the current time is riot within the period of minimum usage of network resources within the CDN, the method moves to step 43 where defragmentation is skipped for this edge node, and the method returns to step 41. When it is determined at step 42 that the current time is within the period of minimum usage of network resources within the CDN, the method moves to step 44 where the edge node retrieves all content popularity timeframe windows from the Redirector server 31. The method then enters loop 45.

Loop 45 encompasses a process performed for each adaptive streaming manifest associated with segment files stored in the edge node's local cache memory. At step 46, the edge node determines whether the current time is within the popularity time window threshold for a particular manifest being analyzed. This is done to ensure the complete piece of electronic content is available when clients are likely to request the segment files. If the current time is not within the popularity time window threshold, the method moves to step 47 where the edge node skips that particular manifest. When it is determined at step 46 that the current time is within the popularity time window threshold for the particular manifest being analyzed, the method moves to step 48 where the edge node reads the master manifest files. The method then enters loop 49.

Loop 49 encompasses a process performed for each child manifest in the master manifest. At step 51, the edge node reads the URLs of the segment files from a particular child manifest. The method then enters loop 52.

Loop 52 encompasses a process performed for each URL in the particular child manifest being analyzed. At step 53, the edge node determines whether a particular segment file exists in the edge node's cache memory. If so, the edge node skips the URL for that segment file at step 54 and moves to the next segment file. This process continues for each of the segment files referenced by the child manifest, and when a referenced segment file is determined to be absent from the edge node's local cache memory, the method moves to step 55 where the edge node utilizes the URL of the absent segment file to pull the absent segment file from another CDN node such as the edge node's parent node or another edge node. The edge node caches the segment file pulled from the other CDN node. When loops 45, 49, and 52 have been performed for each adaptive streaming manifest in cache, for each child manifest in the master manifest, and for each URL in each child manifest, all segment files should exist in the edge node's local cache memory.

Upon verification that all segment files for all manifests exist in the edge node's local cache memory at step 56, the method moves to step 57 where the edge node reports to its parent node that defragmentation is complete.

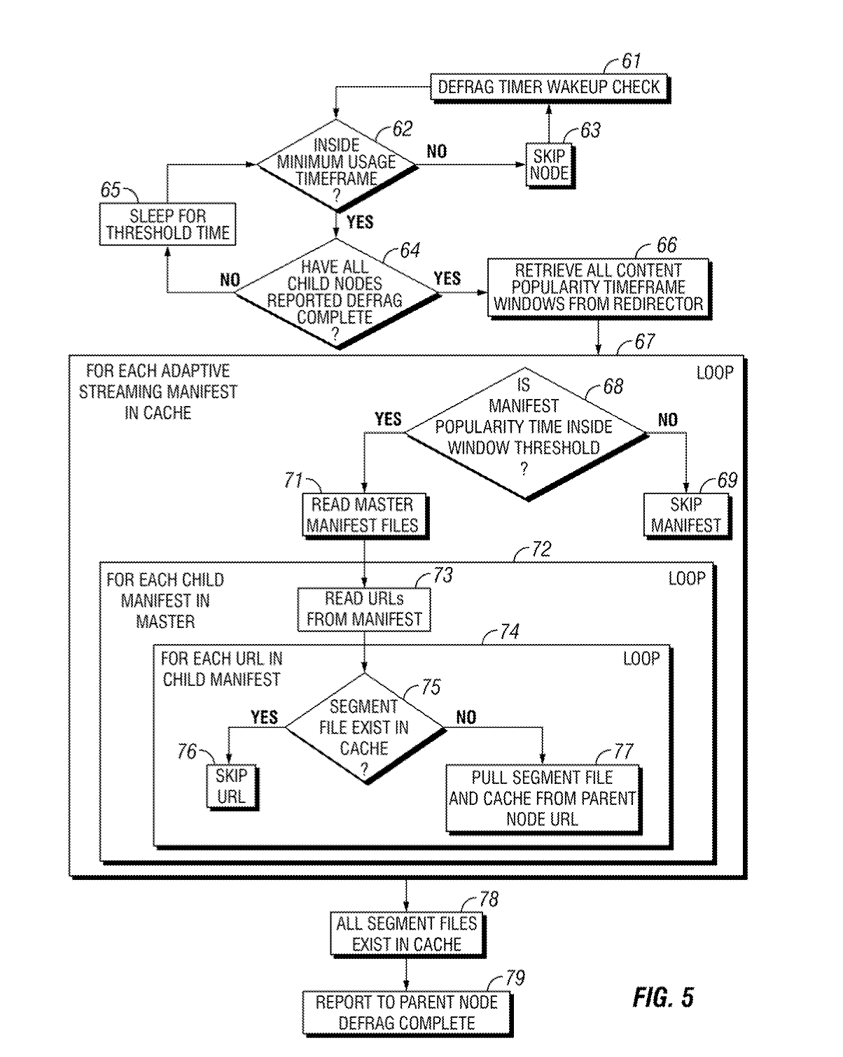

FIG. 5 is a flow chart illustrating the steps of an exemplary embodiment of a segment defragmentation method performed by a parent node such as a regional server in the CDN. Once again, boxes enclosing steps of the method indicate the enclosed steps are looped until, for example, all manifests have been analyzed or all absent segment files have been pulled from a higher level node.

At step 61, the parent node checks a defragmentation wakeup timer, which causes the parent node to determine at step 62 whether the current time is within a period of minimum usage of network resources within the CDN. The parent node may self-calculate the period of minimum usage of network resources if able, and if not able, the parent node receives from a higher level node or from the Redirector server 31 in the CDN, information identifying the period of minimum usage of network resources within the CDN. If the current time is not within the period of minimum usage of network resources within the CDN, the method moves to step 63 where defragmentation is skipped for this parent node, and the method returns to step 61.

When it is determined at step 62 that the current time is within the period of minimum usage of network resources within the CDN, the method moves to step 64 where the parent node determines whether all of its child nodes have reported that their defragmentation is complete. As noted above, during the process of defragmenting the child nodes, the parent node may pull absent files from the higher level node and fill in any absent files in the parent node's cache memory. Therefore, if all of its child nodes have not yet reported that their defragmentation is complete, the parent node sleeps for a threshold time at step 65 to wait for all of its child nodes to report that their defragmentation is complete. The method then returns to step 62 to ensure the current time is still within the period of minimum usage of network resources within the CDN. When it is determined at step 64 that all of the child nodes have reported that their defragmentation is complete, the method moves to step 66 where the parent node retrieves all content popularity timeframe windows from the Redirector server 31. The method then enters loop 67.

Loop 67 encompasses a process performed for each adaptive streaming manifest associated with segment files stored in the parent node's local cache memory. At step 68, the parent node determines whether the current time is within the popularity time window threshold for a particular manifest being analyzed. This is done to ensure the complete piece of electronic content is available when clients are likely to request the segment files. If the current time is not within the popularity time window threshold, the method moves to step 69 where the parent node skips that particular manifest. When it is determined at step 68 that the current time is within the popularity time window threshold for the particular manifest being analyzed, the method moves to step 71 where the parent node reads the master manifest files. The method then enters loop 72.

Loop 72 encompasses a process performed for each child manifest in the master manifest. At step 73, the parent node reads the URLs of the segment files from a particular child manifest. The method then enters loop 74.

Loop 74 encompasses a process performed for each URL in the particular child manifest being analyzed. The parent node reads the master and sub-manifest segment files for a given content to determine whether any segment files referenced by the manifest are absent from the parent node's local cache memory. Thus, at step 75, the parent node determines whether a particular segment file exists in the parent node's cache memory. If so, the parent node skips the URL for that segment file at step 76 and moves to the next segment file. This process continues for each of the segment files referenced by the child manifest, and when a referenced segment file is determined to be absent from the parent node's local cache memory, the method moves to step 77 where the parent node utilizes the URL of the absent segment file to pull the absent segment file from another CDN node such as a higher level node or another parent node. The parent node caches the segment file pulled from the other CDN node. When loops 67, 72, and 74 have been performed for each adaptive streaming manifest in cache, for each child manifest in the master manifest, and for each URL in each child manifest, all segment files should exist in the parent node.

The parent node may perform these operations for each manifest/sub-manifest for each piece of content provisioned within the CDN or just for those manifests staged within the parent node. When the parent node has determined that all segment files for each bitrate, for each piece of content have been pulled from the higher level or other CDN node at step 78, method moves to step 79 where the parent node sends a message to its higher level node indicating that the parent node's defragmentation is complete.

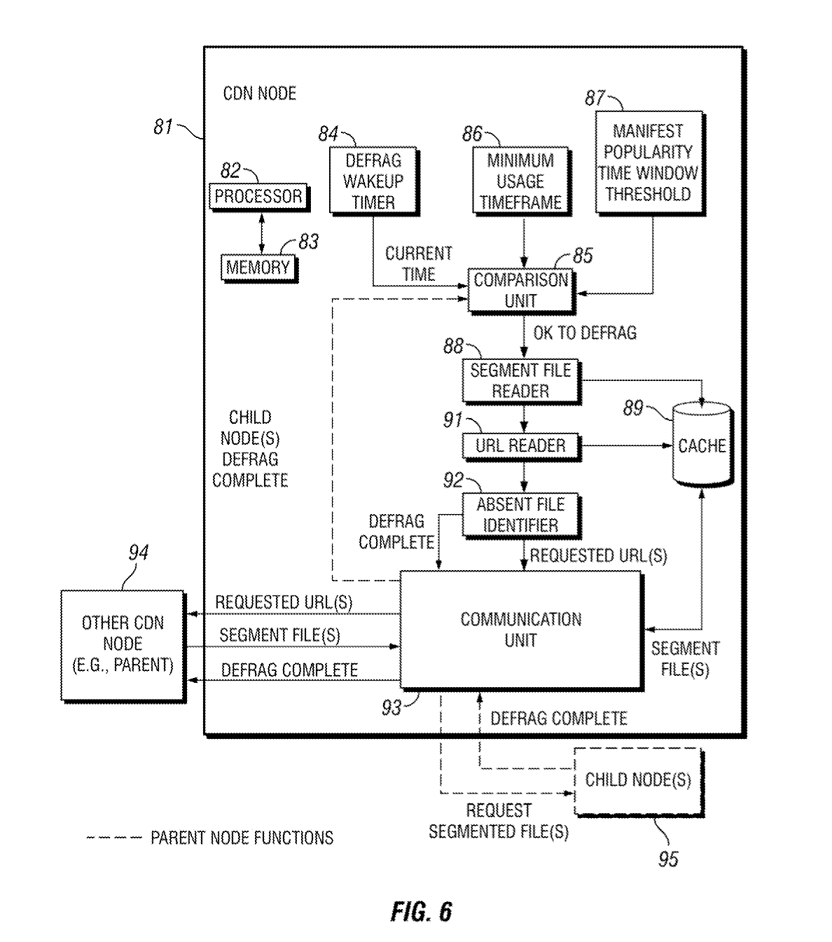

FIG. 6 is a simplified block diagram of an exemplary embodiment of a CDN node 81 configured according to the present disclosure. The functions of the CDN node may be controlled, for example, by a processor 82 executing computer program instructions stored on a memory 83. A defragmentation wakeup timer 84 provides the current time to a comparison unit 85, which compares the current time with the minimum usage timeframe 86. If the current time is within the minimum usage timeframe, the comparison unit further compares the current time with the manifest popularity time window threshold 87. If the current time is within the manifest popularity time window threshold, the comparison unit notifies a segment file reader 88 that it is okay to start the defragmentation process.

The segment file reader 88 reads the segment files from the cache memory 89. A URL reader 91 reads the URLs of each of the segment files referenced by the associated manifest document and provides them to an absent file identifier 92. The absent file identifier identifies one or more referenced segment files that are absent from the local cache memory and sends the associated requested URL(s) to a communication unit 93. The communication unit sends one or more requests for the segment files by sending the requested URL(s) to another CDN node 94, which may be, for example, a parent node. The other CDN node returns the requested segment file(s) to the communication unit, which sends them to the cache 89 for storage. Subsequently, the segment file reader 88 reads the segment files from the cache, and the absent file identifier 92 determines that all segment files reference by the associated manifest document now exist in the cache. The absent file identifier then notifies the communication unit that the defragmentation process is complete. The communication unit 93 then notifies the CDN node's parent node 94 that the CDN node's defragmentation process is complete.

Dashed lines in FIG. 6 indicate additional functionality when the CDN node 81 is also a parent node. As discussed above in connection with FIG. 5, after the comparison unit 85 determines the current time is with the minimum usage timeframe 86, the parent node determines whether all of its child node(s) 95 have reported that their defragmentation process is complete. Once all the child node(s) have reported that their defragmentation is complete, the comparison unit 85 continues by determining whether the current time is within the manifest popularity time window threshold 87. If so, the defragmentation process for the parent node is initiated.

Modifications and other embodiments of the disclosure will come to mind to one skilled in the art having the benefit of the teachings presented in the foregoing descriptions and the associated drawings. Therefore, it is to be understood that the disclosure is not to be limited to the specific embodiments disclosed and that modifications and other embodiments are intended to be included within the scope of this disclosure. Although specific terms may be employed herein, they are used in a generic and descriptive sense only and not for purposes of limitation. Accordingly, the scope of patented subject matter should not be limited to any of the specific exemplary teachings discussed above, but is instead defined by the following claims.

What is claimed is:

1. A method in an edge node of a Content Distribution Network (CDN) for ensuring that a memory of the edge node contains all segment files referenced by an associated manifest document, the method comprising the steps of:
analyzing the associated manifest document and the segment files stored in the memory of the edge node to determine whether any of the segment files referenced by the associated manifest document are absent from the memory of the edge node; and
upon determining there are segment files referenced by the associated manifest document that are absent from the memory of the edge node, pulling the absent segment files from another node in the CDN and storing the pulled segment files in the memory of the edge node.

2. The method as recited in claim 1, wherein the step of pulling the absent segment files from the other node in the CDN includes pulling the absent segment files from a parent node of the edge node or from another edge node.

3. The method as recited in claim 1, wherein the associated manifest document includes a list referencing the segment files that comprise a complete piece of electronic content associated with the manifest document, and the step of analyzing the associated manifest document and the segment files includes:
reading the associated manifest document to identify which segment files comprise the complete piece of electronic content;
determining which segment files are present in the memory of the edge node; and
comparing the present segment files with the list to identify which segment files are absent from the memory of the edge node.

4. The method as recited in claim 3, wherein the list referencing the segment files that comprise the complete piece of electronic content also indicates a Uniform Resource Locator (URL) for each listed segment file, and the step of pulling the absent segment files from the other node includes:
determining the URL for each absent segment file; and
sending the URL for each absent segment file to the other node in a request for the absent segment file.

5. The method as recited in claim 4, wherein when multiple segment files referenced by the associated manifest document are absent from the memory of the edge node, the step of sending the URL for each absent segment file to the parent node includes:
compiling the URLs for the multiple absent segment files into a single request; and
sending the request for multiple absent segment files to the other node.

6. The method as recited in claim 1, further comprising, prior to analyzing the associated manifest document and the segment files, determining that a current time is within a period of minimum usage of network resources within the CDN.

7. The method as recited in claim 6, wherein the edge node self-calculates the period of minimum usage of network resources if able, and if not able, the edge node receives from a parent node or from a Redirector server in the CDN, information identifying the period of minimum usage of network resources within the CDN.

8. The method as recited in claim 6, further comprising, prior to analyzing the manifest document and the segment files, determining that the current time is within a manifest popularity time window threshold to ensure the complete piece of electronic content is available when clients are likely to request the segment files.

9. The method as recited in claim 8, wherein the edge node receives from a Redirector server in the CDN, information identifying the manifest popularity time window threshold.

10. The method as recited in claim 1, further comprising reporting to a parent node that all segment files referenced by the associated manifest document are stored in the memory of the edge node.

11. An edge node of a Content Distribution Network (CDN) configured to utilize adaptive streaming to deliver a piece of electronic content to requesting clients, wherein the piece of electronic content comprises a plurality of segment files referenced by an associated manifest document, wherein the edge node is configured to ensure that a memory of the edge node contains all segment files referenced by the associated manifest document, wherein the edge node includes a processor that executes computer program instructions causing the edge node to:
analyze the associated manifest document and the segment files stored in the memory of the edge node to determine whether any of the segment files referenced by the associated manifest document are absent from the memory of the edge node; and
upon determining there are segment files referenced by the associated manifest document that are absent from the memory of the edge node, pull the absent segment files from another node in the CDN and store the pulled segment files in the memory of the edge node.

12. The edge node as recited in claim 11, wherein the edge node is configured to pull the absent segment files from a parent node of the edge node or from another edge node.

13. The edge node as recited in claim 11, further configured to determine that a current time is within a period of minimum usage of network resources within the CDN prior to analyzing the manifest document and the segment files.

14. The edge node as recited in claim 13, further configured to determine that the current time is within a manifest popularity time window threshold to ensure the complete piece of electronic content is available when the requesting clients are likely to request the segment files.

15. The edge node as recited in claim 11 further configured, after pulling the absent segment files from the parent node, to report to a parent node that all segment files referenced by the associated manifest document are stored in the memory of the edge node.

16. A parent node of a Content Distribution Network (CDN) configured to provide a piece of electronic content to a plurality of child nodes for further distribution to requesting clients utilizing adaptive streaming, wherein the piece of electronic content comprises a plurality of segment files referenced by an associated manifest document, wherein the parent node is configured to ensure that a memory of the parent node contains all of the segment files referenced by the associated manifest document, wherein the parent node includes a processor that executes computer program instructions causing the parent node to:
populate each of the plurality of child nodes with segment files requested by each child node, wherein when a requested segment file is absent from the memory of the parent node, the parent node is configured to pull the requested segment file from a higher level node in the CDN, to send the requested segment file to the requesting child node, and to store the requested segment file in the memory of the parent node;
determine that all of the plurality of child nodes have reported that their manifest documents are complete;
in response to determining that all of the plurality of child nodes have reported that their manifest documents are complete, analyze the associated manifest document and the segment files stored in the memory of the parent node to determine whether any segment files referenced by the associated manifest document are still absent from the memory of the parent node; and
upon determining there are segment files referenced by the associated manifest document that are still absent from the memory of the parent node, pull the absent segment files from the higher level node in the CDN and store the pulled segment files in the parent node.

17. The parent node as recited in claim 16, wherein the associated manifest document includes a list referencing the segment files that comprise the complete piece of electronic content, and the parent node is configured to analyze the associated manifest document and the segment files stored in the memory of the parent node by reading the associated manifest document to identify which segment files comprise the complete piece of electronic content, by determining which segment files are present in the memory of the parent node, and by comparing the present segment files with the list to identify which segment files are absent from the memory of the parent node.

18. The parent node as recited in claim 17, wherein the list referencing the segment files that comprise the complete piece of electronic content also indicates a Uniform Resource Locator (URL) for each listed segment file, and the parent node is configured to pull the absent segment files from the higher level node by determining the URL for each absent segment file, and by sending the URL for each absent segment file to the higher level node in a request for the absent segment file.

19. The parent node as recited in claim 18 wherein when multiple segment files referenced by the associated manifest document are absent from the memory of the parent node, the parent node is configured to compile the URLs for the multiple absent segment files into a single request, and sending the request for multiple absent segment files to the higher level node.

20. The parent node as recited in claim 16, further configured to determine, prior to determining that all of the plurality of child nodes have reported that their manifest documents are complete, that a current time is within a period of minimum usage of network resources within the CDN.

21. The parent node as recited in claim 20, further configured to determine, prior to analyzing the associated manifest document and the segment files stored in the parent node, that the current time is within a manifest popularity time window threshold to ensure the complete piece of electronic content is available when clients are likely to request the segment files.

22. The parent node as recited in claim 16, further configured to report to the higher level node that all segment files referenced by the manifest document are stored in the memory of the parent node.
